(19) United States
(12) Patent Application Publication
(10) Pub. No.: US 2006/0119987 A1
(43) Pub. Date: Jun. 8, 2006

(54) Disk drive head stack assemblies with improved grounding paths

(75) Inventors: King Lok Wong, Saratoga, CA (US); Way-Chet Lim, Petaluma, CA (US)

Correspondence Address: MICHAEL B. EINSCHLAG, ESQ., 25680 FERNHILL DRIVE, LOS ALTOS HILLS, CA, 94024, US

(73) Assignee: RioSpring, Inc., Milpitas, CA (US)

(21) Appl. No.: 11/007,730

(22) Filed: Dec. 8, 2004

(51) Int. Cl. G11B 17/00

(52) U.S. Cl. 360/264.2

(57) ABSTRACT

One embodiment of the present invention is a disk drive head stack assembly with a grounding path between a head and a disk drive ground, the disk drive head stack assembly including: (a) a suspension which carries the head and includes a first portion of the grounding path; and (b) an arm which carries the suspension and which includes a second portion of the grounding path, which second portion is electrically connected to the disk drive ground.

### TECHNICAL FIELD OF THE INVENTION

One or more embodiments of the present invention relate to disk drives, and more particularly, to disk drive head stack assemblies with improved grounding paths.

### BACKGROUND OF THE INVENTION

Grounding paths for disk drive head stack assemblies are important for helping: (a) to provide good signal-to-noise ratios (SNRs) in read/write operations; and (b) to minimize crosstalk caused by electrical magnetic interference (EMI).

Providing grounding paths for disk drive head stack assemblies of small form factor disk drives used in mobile devices markets presents a challenge due to a desire to fit more read/write heads in a limited space. As is well known, thickness is a design constraint in small form factor drives, i.e., the smaller the disk drive thickness, the better the market acceptance. This is so because the market values a thinner and lighter disk drive that can provide a more compact end product, which compact end product will be better for use in mobile computing and storage applications. In light of this, since storage capacity is directly proportional to the number of heads and disks, a present trend is to utilize multiple heads and disks while making the heads (also referred to as sliders) and disks thinner (as is well known, the thickness of the disk drive is affected by the height of the disk drive head stack assembly). Specifically, head or slider designs have progressed through design generations, illustratively, from a mini-slider to a micro-slider, from a micro-slider to a nano-slider, from a nano-slider to a pico-slider, and from a pico-slider to a femto-slider; wherein each new generation has resulted in about a 30% reduction in thickness from the previous generation.

A Giant Magnetoresistive (GMR) head that is typically used in prior art disk drives has four (4) read/write elements (R+, R-, W+ and W-). As such, in a disc drive head stack assembly of a prior art disk drive that uses such GMR heads, each suspension, i.e., flex-on-suspension (FOS) or trace suspension assembly, has: (a) one conductive trace for each of the four (4) read/write elements; and (b) one conductive trace (a grounding trace) that provides a grounding path between the head and a common ground in a flex print circuit assembly (FPCA) of the disk drive. As is well known, and in accordance with prior art designs, the width of each grounding trace becomes a constituent of the height of the head stack assembly, and the whole disk drive receives a contribution to its height from grounding traces that is proportional to the number of its heads. For example, the height of a four-headed disk drive that utilizes GMR heads (such as the GMR head described above) includes the widths of four (4) grounding traces and the width of a grounding trace for each GMR head.

Another problem in providing grounding traces in accordance with the prior art is the cost and time involved in manufacturing disk drives utilizing such grounding traces. In accordance with typical manufacturing methods, each grounding trace is connected to the FPCA by applying a dot of conductive epoxy or by providing a soldering joint. Both methods are time consuming and costly due to: (a) adding additional manufacturing operations; and (b) a need to perform such manufacturing operations inside a class 100 clean room because of outgassing and cleanliness concerns. In addition, such time and cost requirements increase as the number of grounding traces increases.

In light of the above, there is a need in the art for a disk drive head assembly that solves one or more of the above-identified problems.

### SUMMARY OF THE INVENTION

One or more embodiments of the present invention solve one or more of the above-identified problems. In particular, one embodiment of the present invention is a disk drive head stack assembly with a grounding path between a head and a disk drive ground, the disk drive head stack assembly comprising: (a) a suspension which carries the head and comprises a first portion of the grounding path; and (b) an arm which carries the suspension and comprises a second portion of the grounding path, which second portion is electrically connected to the disk drive ground.

### BRIEF DESCRIPTION OF THE DRAWING

FIG. 1 shows a disk drive head stack assembly (HSA) that is fabricated in accordance with one or more embodiments of the present invention wherein conducting traces of the HSA are connected to a flex printed circuit assembly (FPCA) of the disk drive;

FIG. 2 shows a suspension with a 90-degree bend that is one component of the HSA shown in FIG. 1;

FIG. 3 shows an FPCA wherein part of its height is determined by a number of conducting traces emanating from the HSA shown in FIG. 1;

FIG. 4 shows a grounding pin of the HSA shown in FIG. 1; and

FIG. 5 shows the grounding pin shown in FIG. 4 being connected to a spacer of the HSA shown in FIG. 1.

### DETAILED DESCRIPTION

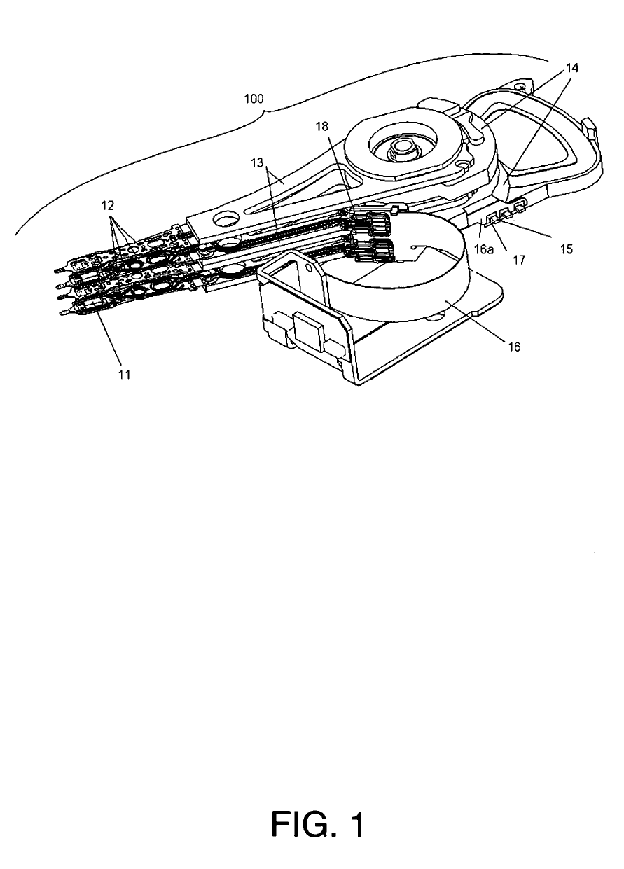

FIG. 1 shows disk drive head stack assembly (HSA) 100 that is fabricated in accordance with one or more embodiments of the present invention wherein conducting traces of HSA 100 are connected to flex printed circuit assembly (FPCA) 16 of the disk drive (not shown). As shown in FIG. 1, HSA 100 comprises heads 11, also referred to herein as sliders 11 (as shown in FIG. 1, HSA 100 includes four heads or sliders). As further shown in FIG. 1, heads 11 are electrically connected to and carried on suspensions 12. In accordance with one or more embodiments of the present invention, the electrical connections may be provided, for example and without limitation, by use of a conductive trace. As further shown in FIG. 1, suspensions 12 are electrically connected to and carried on arms 13. In accordance with one or more embodiments of the present invention, the electrical connections may be provided: (a) by fabricating each component (suspension and arm) from a conductive material such as, for example and without limitation, steel; (b) by use of conductive elements such as, for example and without limitation, conductive traces, in each component (suspension and arm); or (c) by use of a combination of a conductive component (suspension or arm) and a conductive element in the other.

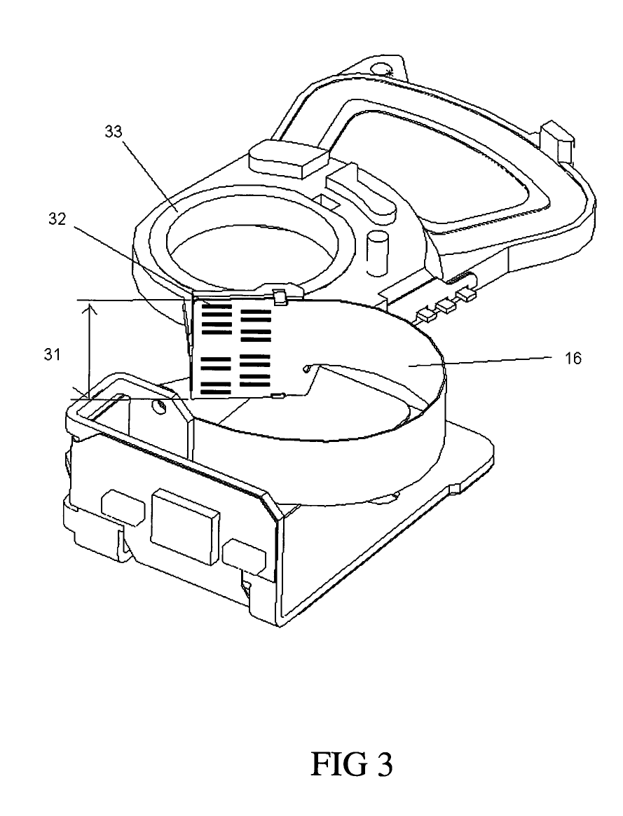

As further shown in FIG. 1, arms 13 are separated from each other by spacers 14, and arms 13 are electrically connected to adjacent ones of spacers 14 through contact of conductive elements therein. In accordance with one or more embodiments of the present invention, the electrical connection may be provided: (a) by fabricating each component (arm and spacer) from a conductive material such as, for example and without limitation, steel; (b) by use of conductive elements such as, for example and without limitation, conductive traces, in each component (arm and spacer); or (c) by use of a combination of a conductive component (arm or spacer) and a conductive element in the other. In accordance with one or more embodiments of the present invention, and as shown in FIG. 3, spacers 14 are electrically connected to each other through contact at conductive inner ring 33.

Lastly, as shown in FIG. 1, grounding pin 15 is electrically connected between one of spacers 14 to short tail 16a of FPCA 16 by, for example and without limitation, solder joint 17. In accordance with one or more embodiments of the present invention, the electrical connection may be provided: (a) by fabricating each component (spacer and grounding pin) from a conductive material such as, for example and without limitation, steel; (b) by use of conductive elements such as, for example and without limitation, conductive traces, in each component (spacer and grounding pin); or (c) by use of a combination of a conductive component (spacer or grounding pin) and a conductive element in the other. In accordance with one or more embodiments of the present invention, short tail 16a serves as a ground for the disk drive (not shown). Thus, in accordance with one or more embodiments of the present invention, and as was described above, grounding paths are provided from heads 11 to short tail 16a which serves as a ground of the disk drive.

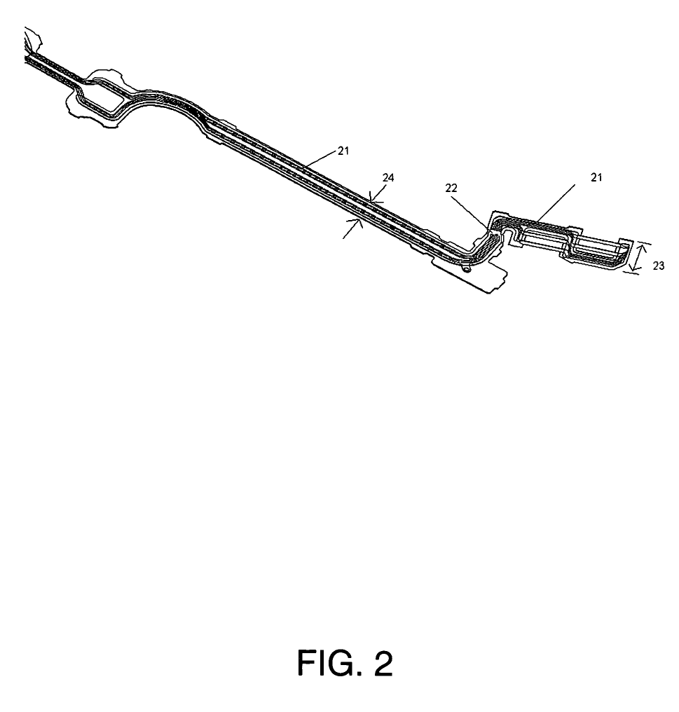

As shown in FIG. 1, conductive traces emanating from heads 11 are carried on suspensions 12 (a suspension is also referred to as a flex-on-suspension (FOS) or a trace suspension assembly), and are connected to FPCA 16 at suspension-FPCA connections 18. FIG. 2 shows an embodiment of suspension 12 (FOS 12). As shown in FIG. 2, conductive traces 21 of FOS 12 are laid out in a side-by-side configuration. However, in order to align properly with the orientation of suspension-FPCA connections 18 of FPCA 16, suspension 12 has a 90-degree bend 22 so that conductive traces 21 may have a proper orientation with respect to suspension-FPCA connections 18 shown in FIG. 1. As one can readily appreciate, given a fixed width of a conductive trace, the number of conductive traces 21 determines width 24 of suspension 12 prior to 90-degree bend 22 and height 23 of suspension 12 after 90-degree bend 22. Thus, given 90-degree bend 22, width 24 (and hence height 23) of suspension 12 determines the minimum height of FPCA 16, and hence determines the minimum thickness of the disk drive. Advantageously in accordance with one or more embodiments of the present invention, as was described above, the width of suspension 12 is reduced. For example, in a typical prior art giant magnetoresistive (GMR) head having four read/write elements (R+, R-, W+ and W-), the number of conductive traces 21 on each suspension of suspensions 12 is five. By providing grounding paths in accordance with one or more embodiments of the present invention, the number of conductive traces 21 may become four, and the per-head minimum height may be reduced by the width of a grounding trace.

FIG. 3 shows FPCA 16 wherein part of its height 31 is determined by a number of conducting traces emanating from HSA 100 shown in FIG. 1. In addition, the minimum of height 31 is determined by the number of conducting traces emanating from HSA 100 because the number of conducting traces determines the number of contact points 32 on FPCA 16, and each of contact points 32 has a predetermined height. Thus, for four-headed HSA 100 shown in FIG. 1, based on grounding in accordance with one or more embodiments of the present invention, the number of contact points 32 shown in FIG. 3 is sixteen whereas, in a prior-art four-head disk drive, the number of contact points 32 would have been twenty. In addition, providing grounding traces in accordance with one or more embodiments of the present invention can advantageously save cost and time in disk drive manufacturing.

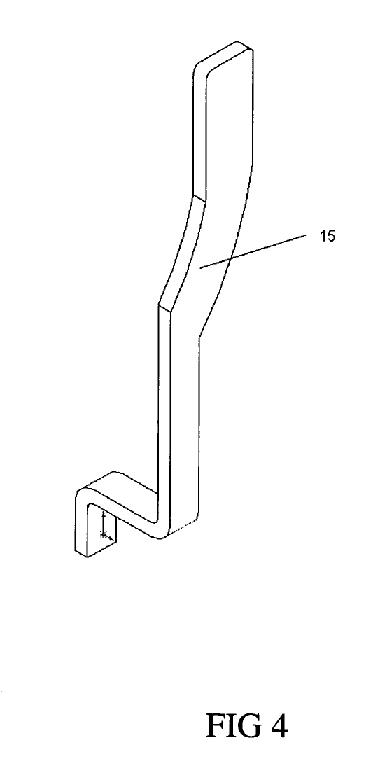

FIG. 4 shows grounding pin 15 of HSA 100 that is fabricated from conductive material in accordance with one or more embodiments of the present invention.

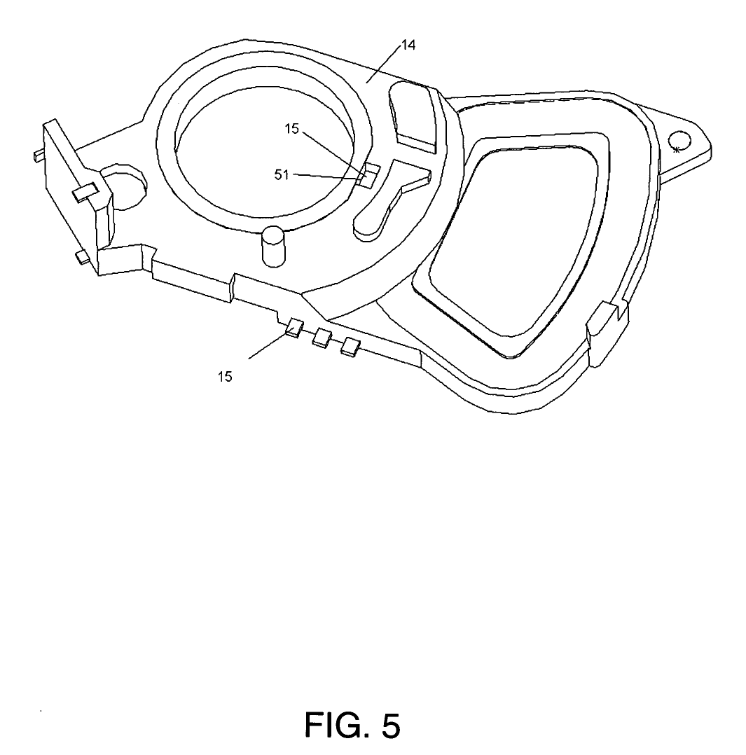

FIG. 5 shows grounding pin 15 of FIG. 4 being connected to spacer 14. In accordance with one or more embodiments of the present invention, grounding pin 15 is connected by laser tacking using dot 51 of conductive epoxy wherein laser tacking is well known to those of ordinary skill in the art. Advantageously, the use of laser tacking in accordance with one or more embodiments of the present invention provides low electrical resistance. In addition, and in accordance with one or more further embodiments of the present invention, an end of grounding pin 15 is covered with conductive epoxy, and the epoxy is conventionally cured. Advantageously, after being fully cured, the conductive epoxy provides better conduction and good adhesion. In further addition, and in accordance with one or more further embodiments of the present invention, a substantial part of grounding pin 15 may be covered by overmold, i.e., covered by a nonconductive material, so that only its contacting ends are exposed.

Advantageously, a disk drive fabricated in accordance with one or more embodiments of the present invention and utilizing a particular head design may have: (a) a reduced height for a predetermined number of heads; or (b) an increased storage capacity for a predetermined height due to an ability to utilize more heads. In addition, the cost and time for manufacturing the disk drive may be reduced.

The embodiments of the present invention described above are exemplary. Many changes and modifications may be made to the disclosure recited above, while remaining within the scope of the invention. The scope of the invention should, therefore, be determined not with reference to the above description, but instead should be determined with reference. to the appended claims along with their full scope of equivalents.

What is claimed is:

1. A disk drive head stack assembly with a grounding path between a head and a disk drive ground, the disk drive head stack assembly comprising:
a suspension which carries the head and comprises a first portion of the grounding path; and
an arm which carries the suspension and comprises a second portion of the grounding path, which second portion is electrically connected to the disk drive ground.

2. The disk drive head stack assembly of claim 1 wherein the suspension is conductive.

3. The disk drive head stack assembly of claim 1 wherein the arm is conductive.

4. The disk drive head stack assembly of claim 1 which further comprises a spacer which is electrically connected to the arm and the disk drive ground.

5. The disk drive head stack assembly of claim 4 which further comprises further spacers which are electrically connected to each spacer of the disk drive head stack assembly and the disk drive ground.

6. The disk drive head stack assembly of claim 4 which further comprises a conductive means for electrically connecting the spacer and the disk drive ground.

7. The disk drive head stack assembly of claim 4 which further comprises a grounding pin which is electrically connected to the spacer and the disk drive ground.

8. The disk drive head stack assembly of claim 4 wherein one or more of the suspension, the arm, and the spacer comprise conductive material.

9. The disk drive head stack assembly of claim 5 wherein the spacers comprise conductive material.

10. The disk drive head stack assembly of claim 8 wherein the conductive material is metallic.

11. The disk drive head stack assembly of claim 7 wherein an end of the grounding pin is electrically connected to the one of the spacers with a laser tacked conductive epoxy.

12. The disk drive head stack assembly of claim 7 wherein an end of the grounding pin is covered by overmold.

13. The disk drive head stack assembly of claim 1 wherein the disk drive ground is a short tail of a flex printed circuit assembly of the disk drive.
